(19) United States
(12) Patent Application Publication
(10) Pub. No.: US 2005/0249484 A1
(43) Pub. Date: Nov. 10, 2005

(54) Wireless digital music playing and transmitting device for portable DVD/CD player

(76) Inventors: Man Dor Ng, Kowloon City (HK); Ya Bin Cao, Long Gang Town (CN); Ming Xin Wang, Long Gang Town (CN)

Correspondence Address: RABIN & BERDO, P.C., Suite 500, 1101 14th Street, N.W., Washington, DC, 20005, US

(21) Appl. No.: 11/125,070

(22) Filed: May 10, 2005

(30) Foreign Application Priority Data
May 10, 2004 (HK) 04103247.1

(51) Int. Cl. H04N 5/781

(52) U.S. Cl. 386/125; 386/126

(57) ABSTRACT

A wireless digital music playing and transmitting device installed on the portable DVD/CD player wherein a transmitter having a functional interface consists of a central processing and audio frequency AD converting circuit, a radio-frequency module, an indicating lamp and a power control circuit; output terminals of the central processing and audio frequency AD converting circuit are connected to the radio frequency module, the indicating lamp and the power control circuit; a receiver consists of at least one set of switching circuits, a radio-frequency receiving module, a central processing and AD converting circuit and an audio-frequency amplifier circuit; output terminals of said radio-frequency receiving module are connected to the central processing and AD converting circuit, output terminals of the central processing and AD converting circuit are connected to the audio-frequency amplifier circuit which is provided with a functional interface.

### BACKGROUND OF THE INVENTION

1. Field of the Invention

The present invention relates to wireless digital music player, and more particularly to a personal short distance wireless digital music playing system and voice transmitting device for portable DVD/VD player.

2. Description of the Related Art

Standard of living of populace is improving along with social development and technological advancement while life of household has been enriched by home theater or sound system. In the mean time, educational home theater or sound system are very difficult to be installed and debugged due to complex and lengthy wires connecting between the power amplifier and loudspeaker whilst the reliability and aesthetic layout of the entire system is affected by the overwhelming peripheral wires and interface. Therefore, one has to consider the difficulties of laying out wires while decorating the living room; otherwise it is not going to be easy for installation and the exposed wires are affecting the aesthetic feeling. Furthermore, one can enjoy the personal wireless digital music CD and watching personal home theater DVD as a personal sound system by replacing the loudspeaker with mini-pocket receiver without disturbing the others. Personal translator is a must when student needs translation, which is also necessary when foreign teacher is teaching or translating foreign language while traveling, visiting, and conferencing.

### SUMMARY OF THE INVENTION

An object of the present invention is aimed at deficiencies in wireless education or sound equipment and is to provide a multifunctional wireless digital music playing and transmitting device for DVD/CD player, which is adapted for typical DVD/CD player playing at mobile or non-mobile situation; the device can be also used for wireless digital music transmission for a number of rooms, personal wireless music player for short distance and wireless multifunction transmitter for short distance and non-mobile. Furthermore, audience's enjoyment can be enhanced, using wireless digital music playing and transmitting DVD/CD player as a personal player, and by which you, during the journey of sightseeing, may listen to the guide's narration with music background.

The present invention of wireless digital music playing and transmitting device for portable DVD/CD player, characterized in that the transmitter comprises central processing and audio frequency AD (analog/digital) converting circuit, a radio frequency module, an indicating lamp and a power control circuit; output terminals of the central processing and audio frequency AD converting circuit are connected to the radio frequency module, the indicating lamp and the power control circuit; the transmitter is provided with a functional interface which is capable of connecting DVD/CD player or microphone; a receiver comprises at least one set of switching circuit, a radio frequency receiving module, a central processing and AD converting circuit and an audio frequency amplifier circuit; output terminals of said radio frequency receiving module are connected to the central processing and AD converting circuit; output terminals of the central processing and AD converting circuit are connected to the audio frequency amplifier circuit, and the audio frequency amplifier circuit is provided with a functional interface connecting to a loudspeaker.

The present invention of wireless digital music playing and transmitting device for portable DVD/CD player, characterized in that the device is also provided with a remote controller. Groups of broadcasting apparatus can be turned on and off simultaneously using the remote controller while using the wireless digital music room loudspeaker for playing.

The principle of operation of the present invention of wireless digital music playing and transmitting device for portable DVD/CD player is that the functional interface of the transmitter is connected to the wireless digital music playing and transmitter device for portable DVD/CD player or microphone; audio frequency signal from DVD/CD player or the microphone is processed by the central processing and AD converting circuit of the transmitter, and then transmitted to the space via radio frequency module in order to be received and player by a number of receivers, which match with the transmitter.

The design and configuration of wireless digital music playing and transmitting device for portable DVD/CD player according to the present invention are rational; interference can be greatly reduced and timbre can be reverted by wirelessly transmitting digital signal to which audio signal is converted, and then converting the digital signal received by the receiver to audio frequency to play; therefore, the device implements one player with multi-playback function for playing wireless background music at home or office and personal wireless digital music as well as for transmitting digital voice in speech; in other words, wireless digital playing and transmitting device for portable DVD/CD player with music data transmitter and a number of wireless digital receivers can fulfill the need of multi-room wireless playback, personal stereo and wireless headphone playback when transmitting.

The configuration of wireless digital music playing and transmitting device for portable DVD/CD player according to the present invention will be described in more detail below with the help of exemplary embodiments in reference to the accompanying drawings in which:

### BRIEF DESCRIPTION OF THE DRAWINGS

FIG. 1 is a block diagram of wireless digital music playing and transmitting device for portable DVD/CD player wherein A indicates loudspeakers for playback of wireless digital music in the rooms; B indicates a wireless digital music short distance personal stereo and C indicates a wireless music plus instantaneous voice transmission;

FIGS. 2A, 2B, 2C, 2D, 2E, 2F, 2G, 2H, 21, 2J, 2K, 2L, 2M, and 2N are schematic diagrams 1 of the circuits of wireless digital music playing and transmitting device for portable DVD/CD player and circuitry of the transmitter shown in FIG. 1;

FIGS. 3A, 3B, 3C, 3D, 3E, and 3F are schematic diagrams of the circuitry of the receiver of wireless digital music playing and transmitting device for portable DVD/CD player shown in FIG. 1;

FIGS. 4A and 4B are circuit diagrams of the remote controller, and

### DETAILED DESCRIPPTION OF THE INVENTION

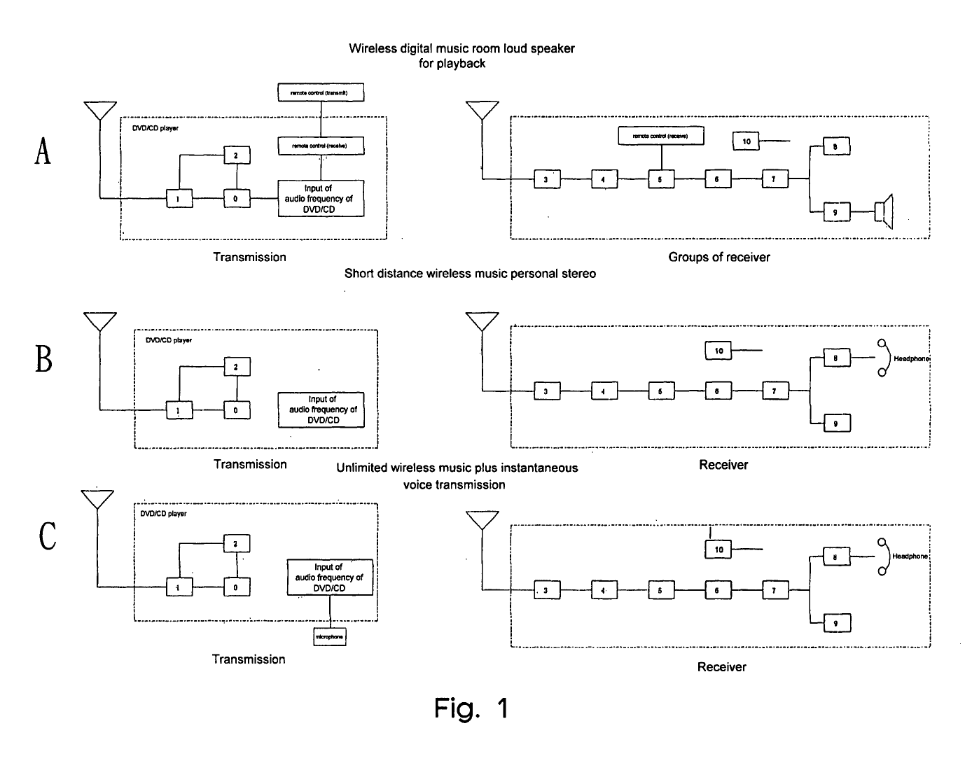

As seen clearly from FIG. 1, the wireless digital music playing and transmitting device for portable DVD/CD player includes: a transmitter having frequency conversion function, which consists of a central processing and audio frequency AD converting circuit 0, a radio frequency transmitting circuit 1, an indicating lamp and a power control circuit 2; and a receiver having frequency conversion function, which consists of at least one set of switching circuits 10, a radio frequency receiving circuit 3, a phase lock loop and local oscillator circuit 4, an intermediate demodulating circuit 5, a single-chip control circuit 6, a central processing and AD converting circuit 7 and an headphone audio frequency amplifying circuit 8, a loudspeaker and a sound box circuit 9, and which can be used for non-mobile situation and transmitting and receiving of remote controller controlled by the receiver.

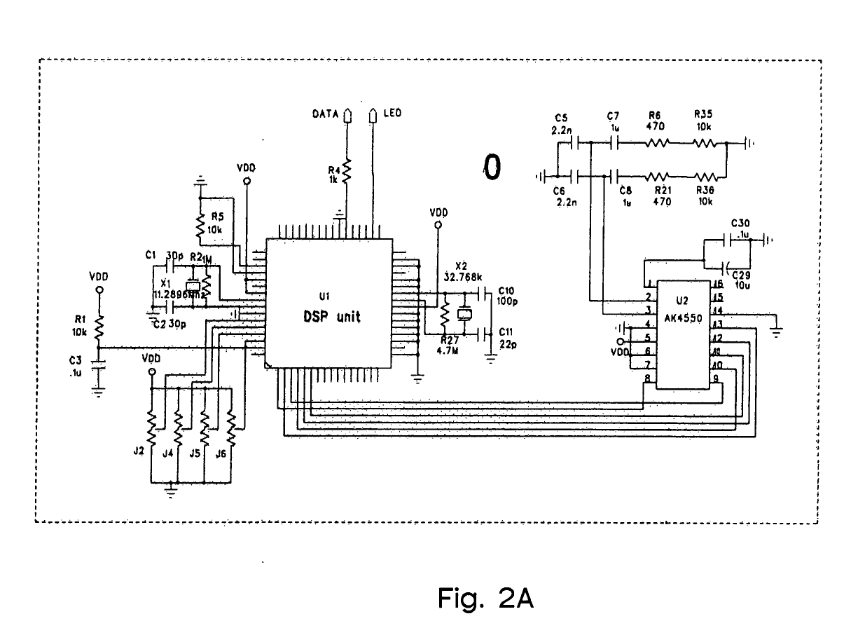

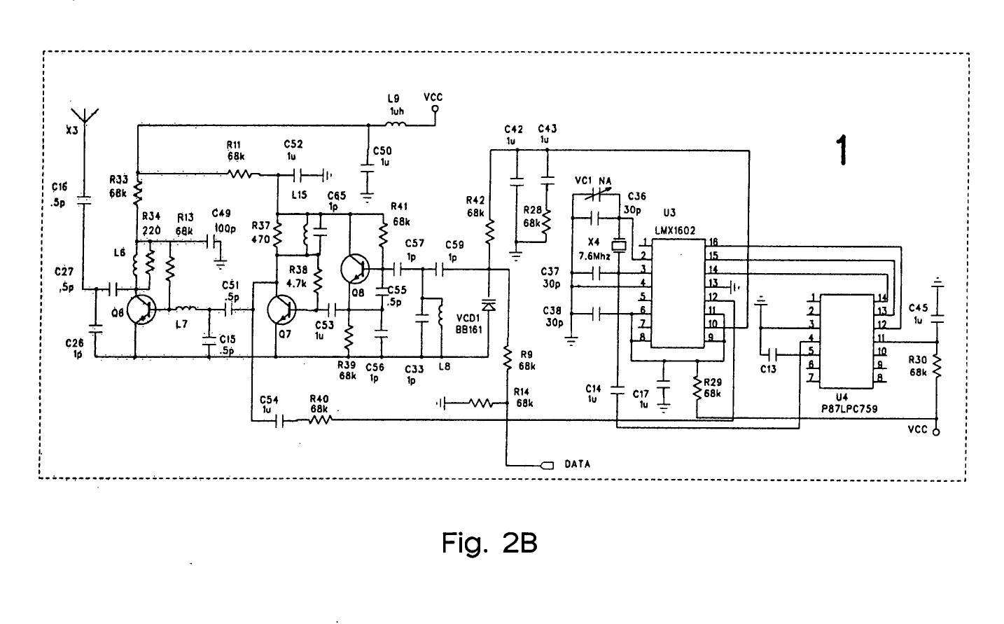

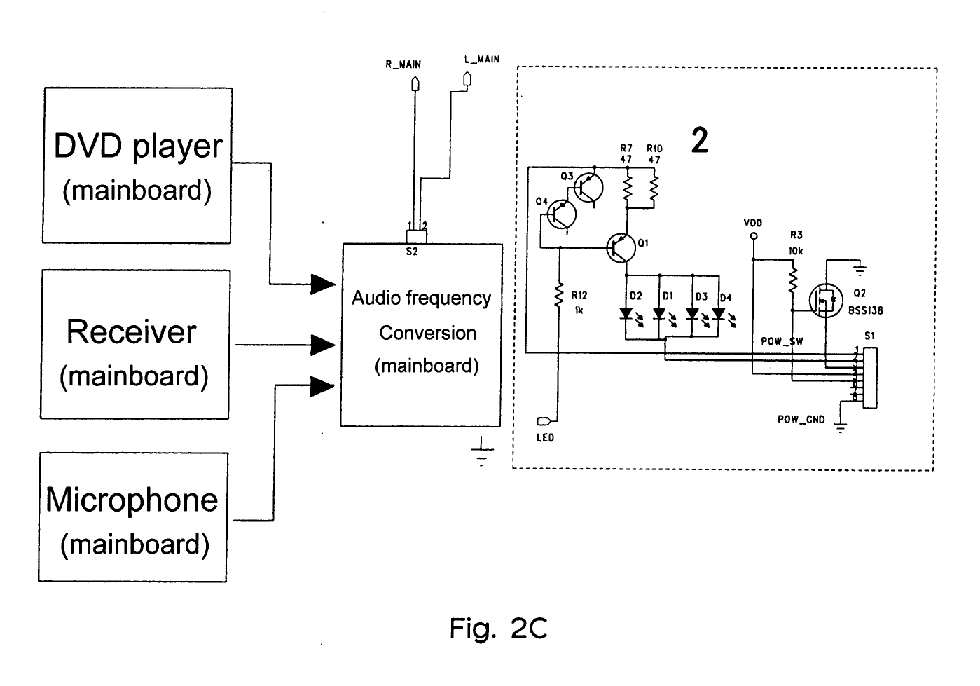

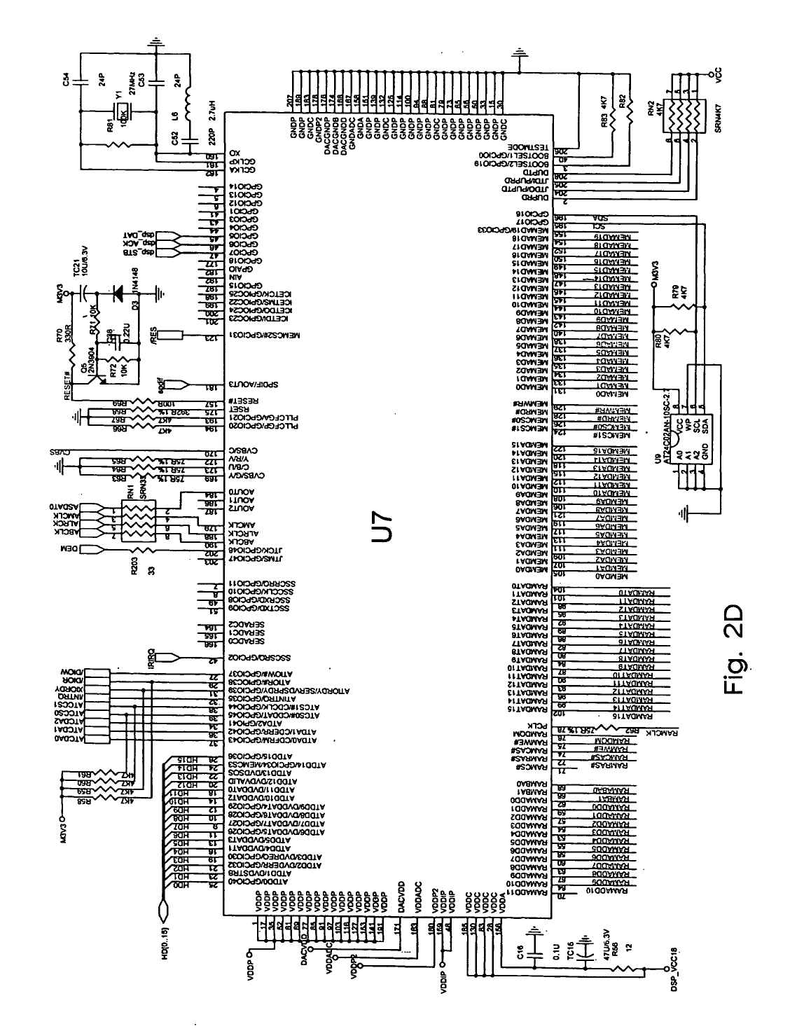

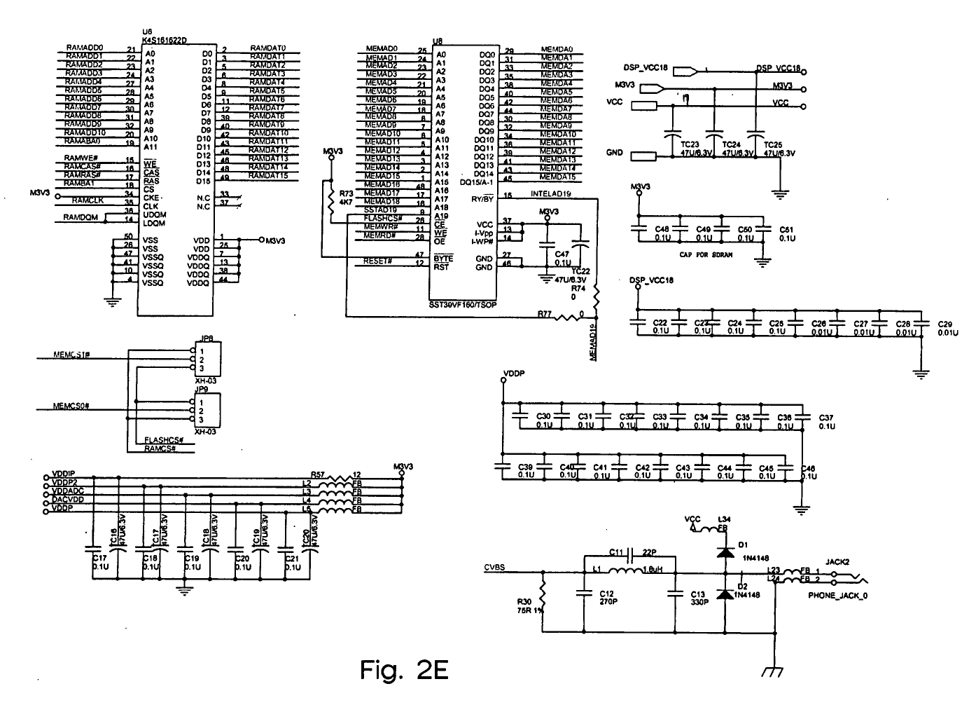

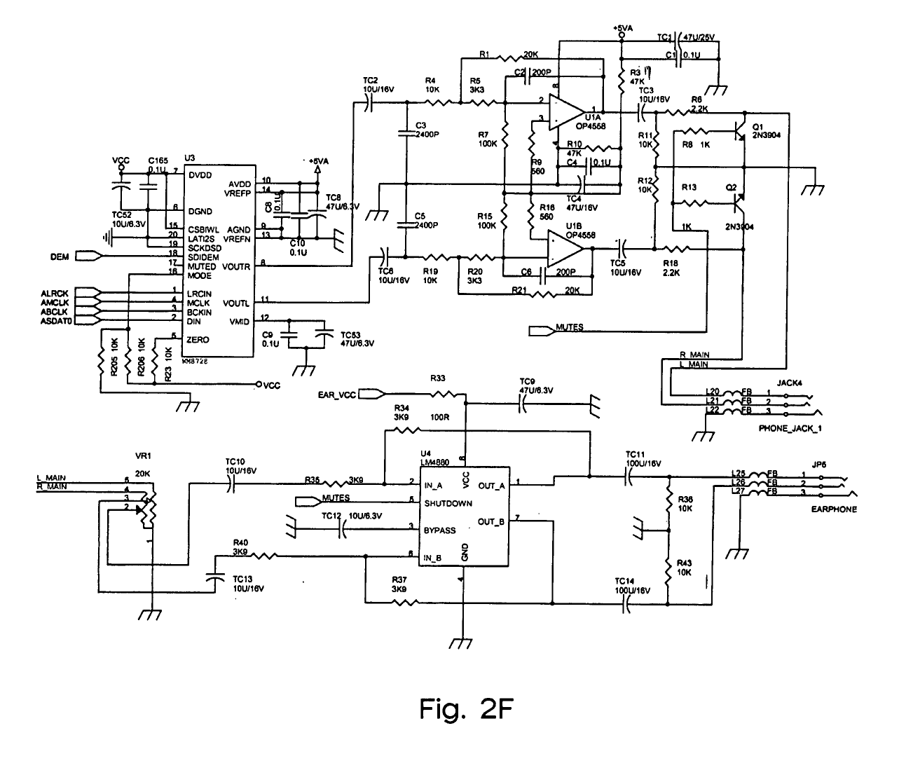

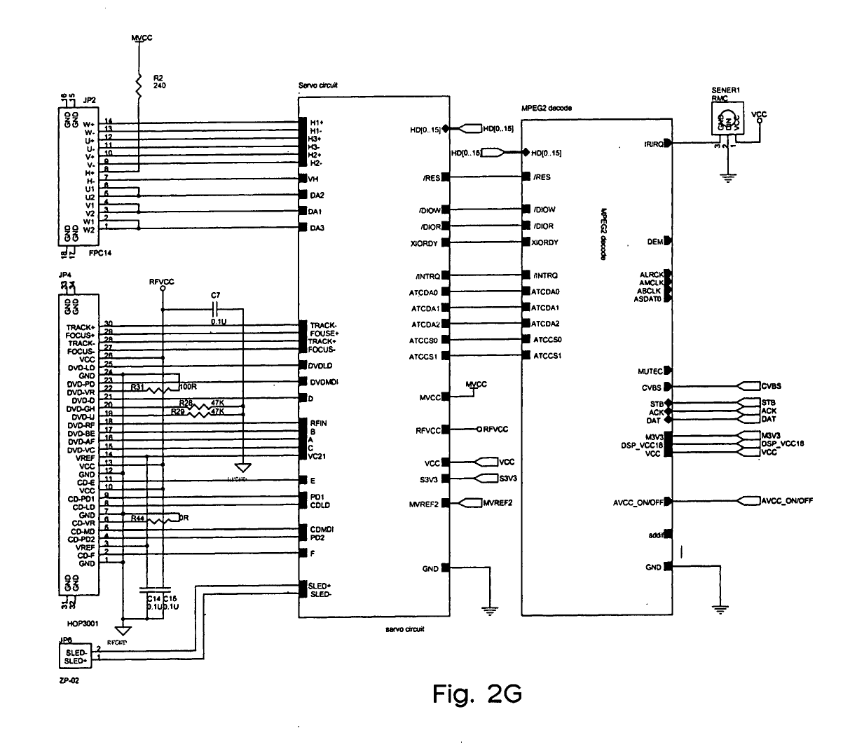

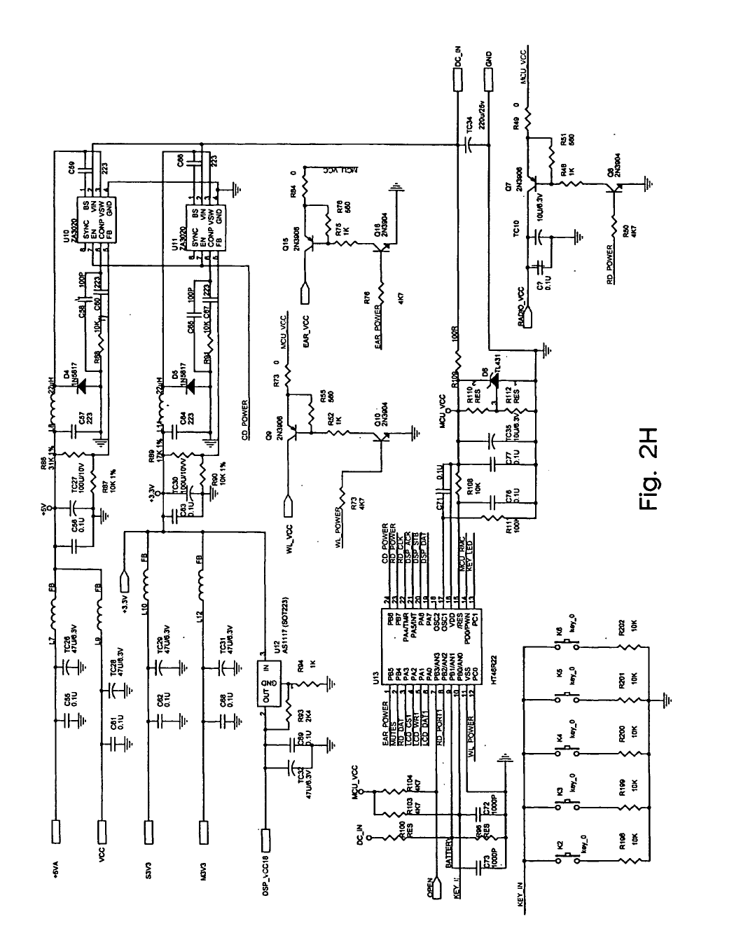

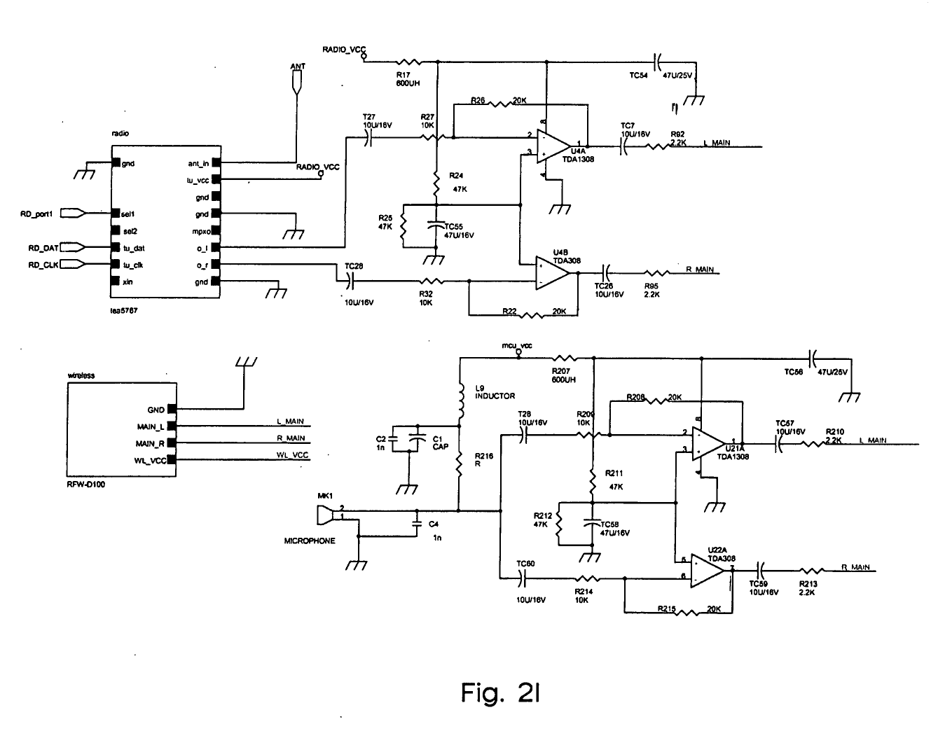

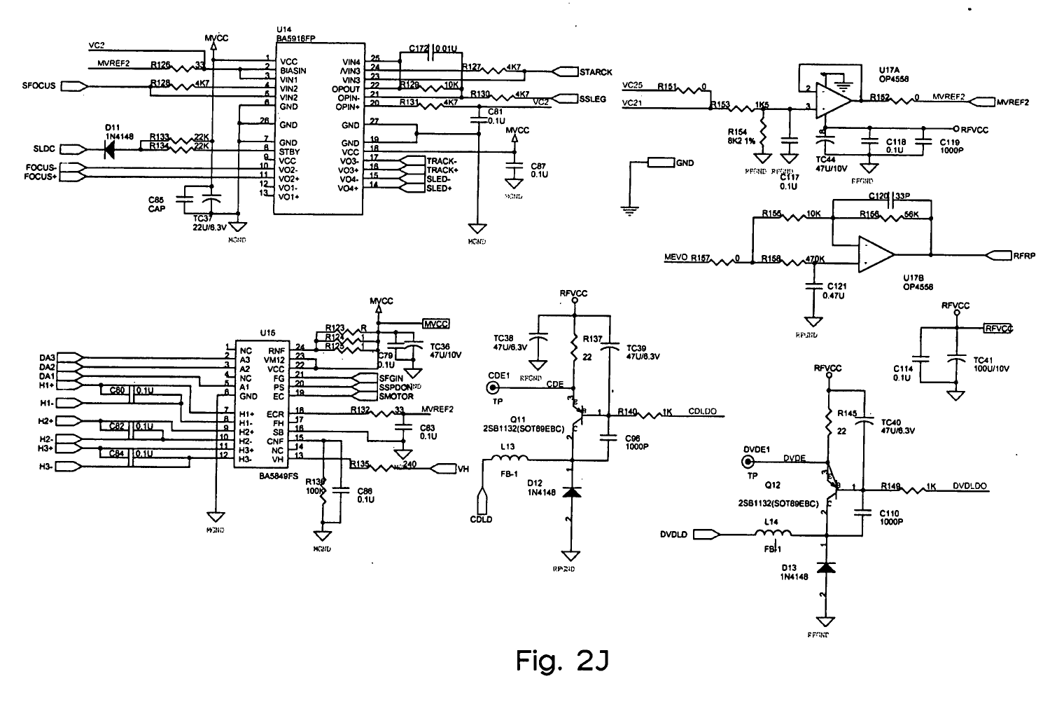

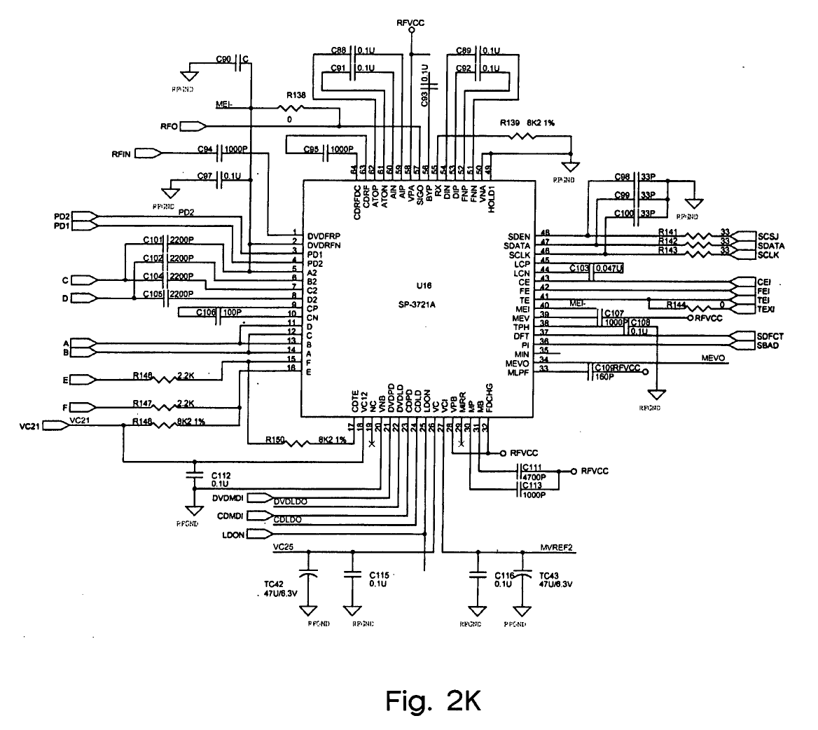

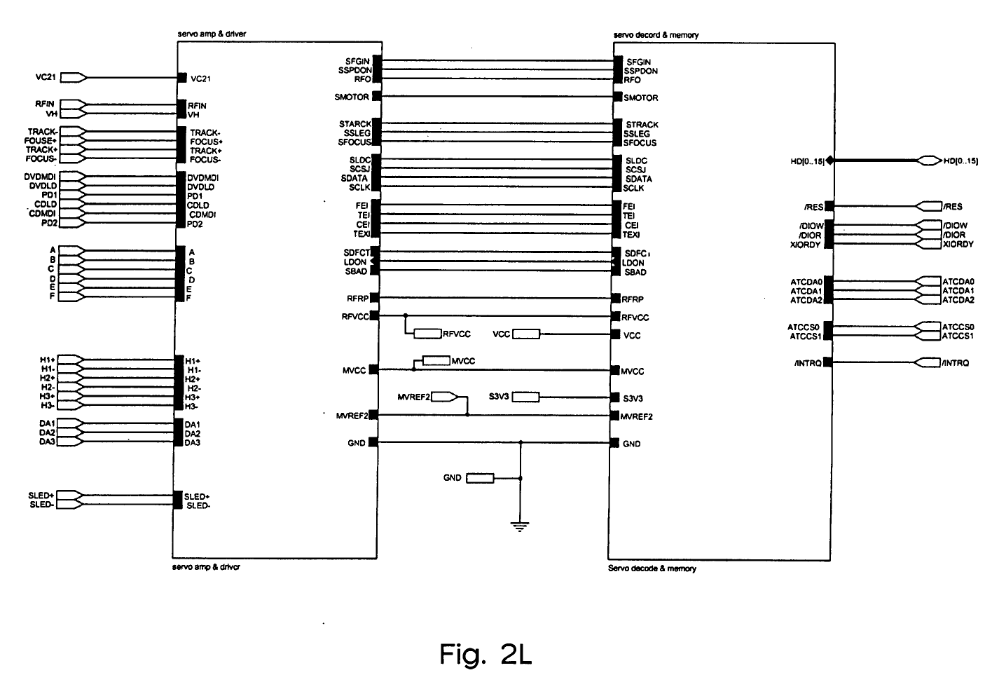

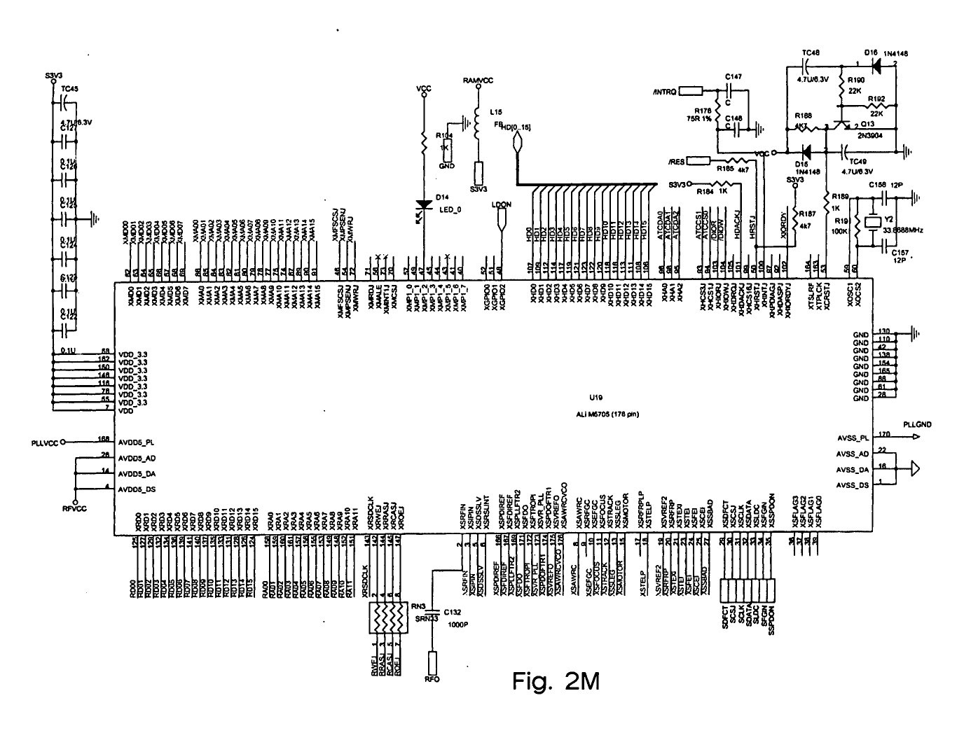

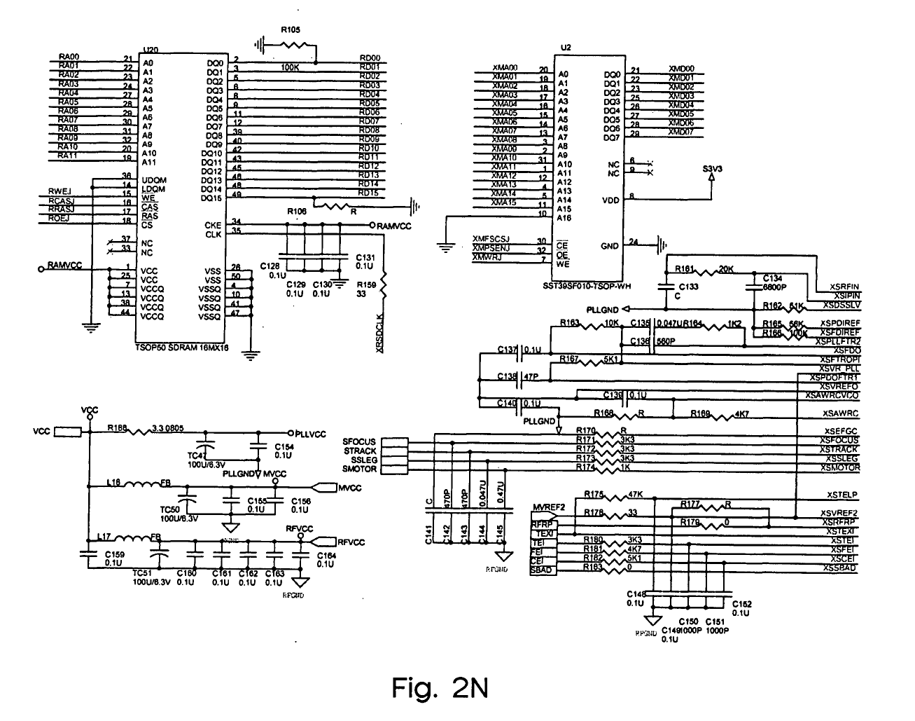

FIG. 2A shows a substantial configuration of the transmitter wherein the central processing and AD converting circuit 0 of the transmitter consists of a digital signal processor U1 , an audio frequency module AD converter U2, a first clock circuit X1 and a second clock circuit X2; audio frequency AD module converter U2 is a AK4550 and its operating clock (including master clock MCLK, input/output channel clock LRCK and audio serial data clock SCLK) is provides by digital signal processor U1; the digital signal processor U1 is an interface IC implementing the connection of the audio frequency module AD converter U2 with the radio frequency transmitting circuit 1; the audio frequency data is transmitted to the radio frequency module M1 of radio frequency transmitting circuit 1 and control signal which sent back from the receiver is received. The functional interface of the audio frequency AD converter U2 is provided with a functional interface connecting to output terminal of DVD/CD player or microphone or radio; the audio frequency signal is sent to the audio frequency input terminal of the audio frequency AD converter U2 of the transmitter through the functional interface for AD conversion; the audio serial data output SDTO signal is output to the digital signal processor U1 and the clock signal required by the audio frequency AD converter U2 is provided by the digital signal processor U1.

Data are compressed after digital signal processor U1 receives the audio serial data output SDTO signal and are then modulated to binary pulse signal for radio frequency transmitting circuit 1.

In FIG. 2B, the radio frequency transmitting circuit consists of a voltage-controlled oscillator VCO, a radio frequency transmitting circuit and a phase lock loop circuit whilst VCD circuit consists of triodes Q7, Q8 and peripheral units. The phase lock loop circuit consists of phase lock loop U3 and single-chip U4. The single-chip U4 gives off frequency needed by U3 and U3 controls the VCD to tune the voltage. The frequency in demand is locked. The data signal is added to VCD through resistors R4, R9 for FSK modulation.

In FIG. 2C, the indicating lamp and power control circuit 2 includes four light emitting diodes D1, D2, D3 and D4 and the switch controlling circuit consisting of resistor R3 and field effect transistor Q2. The light emitting diodes indicate the status of the entire device, in which when blinking it is in a standby mode and when constantly luminescing it is in an operation mode. The POW-SW is high voltage level when the switch controlling circuit is in operation; the gate of field effect transistor Q2 is at high voltage level, and the field effect transistor Q2 is conducted, whereby the entire device is connected to the earth and the entire device is turned on. POW-SW is low voltage level when the receiver is charged and the field effect transistor Q2 is cut off, with the result that the entire device is turned off.

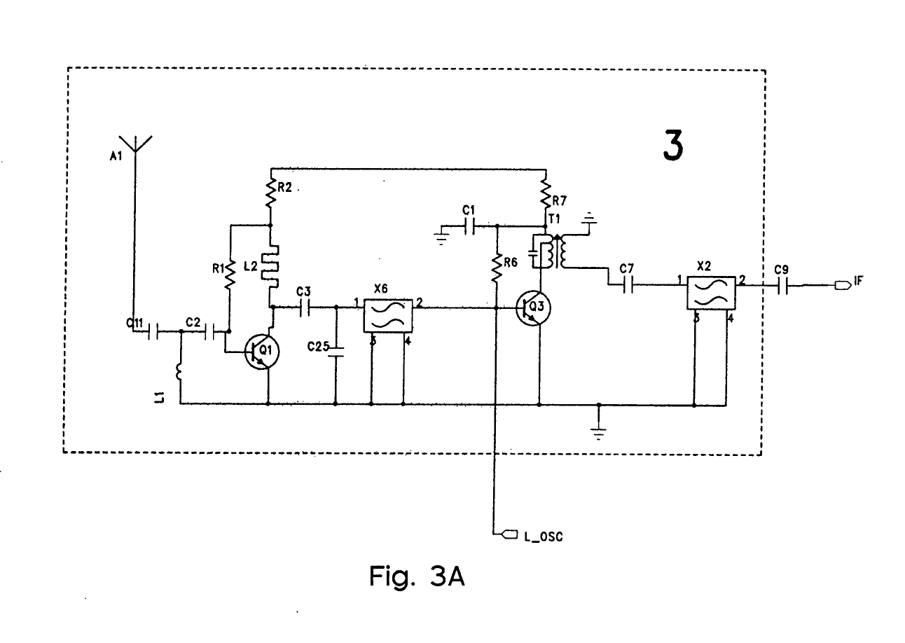

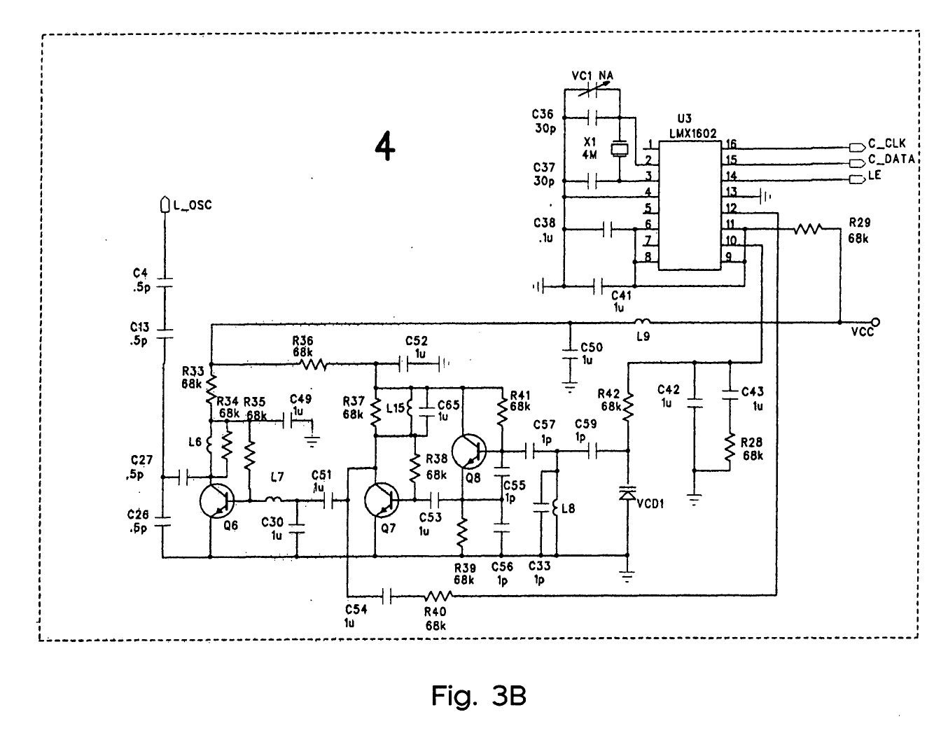

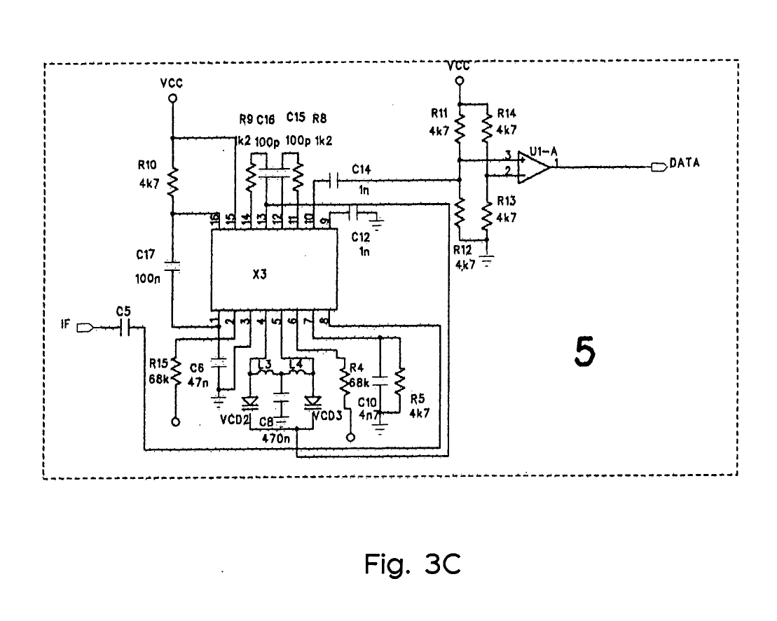

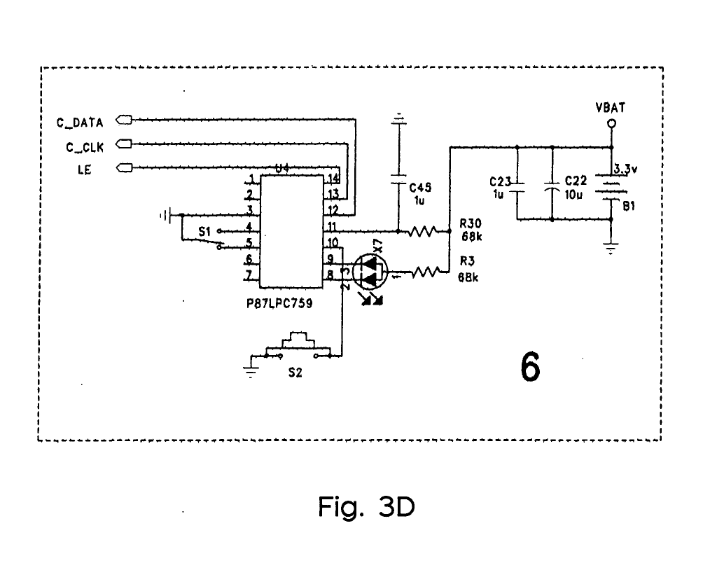

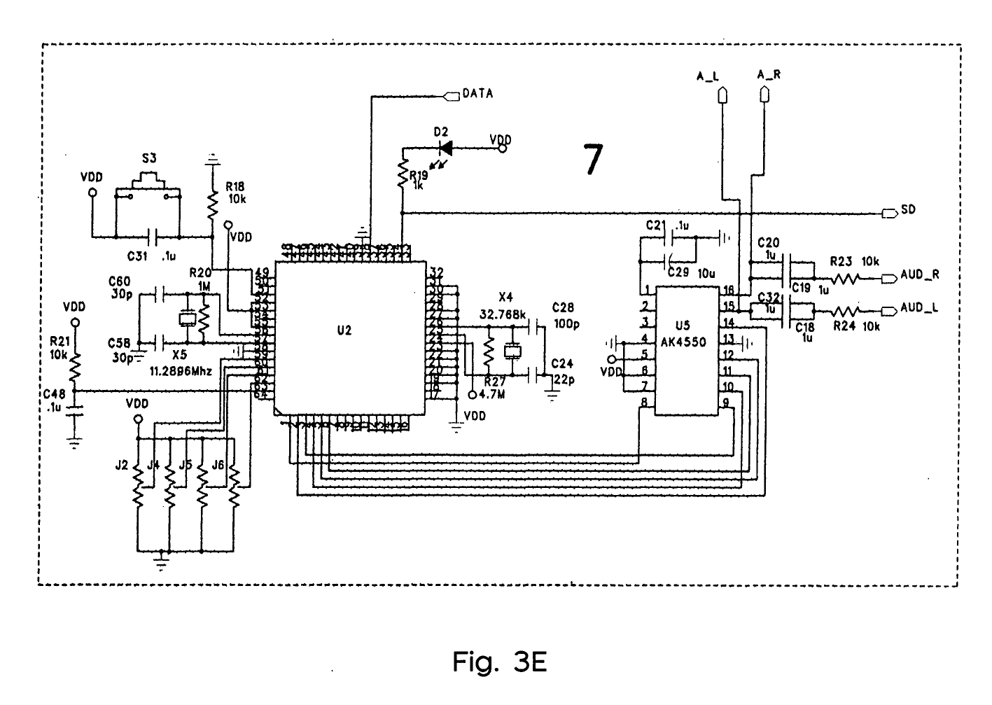

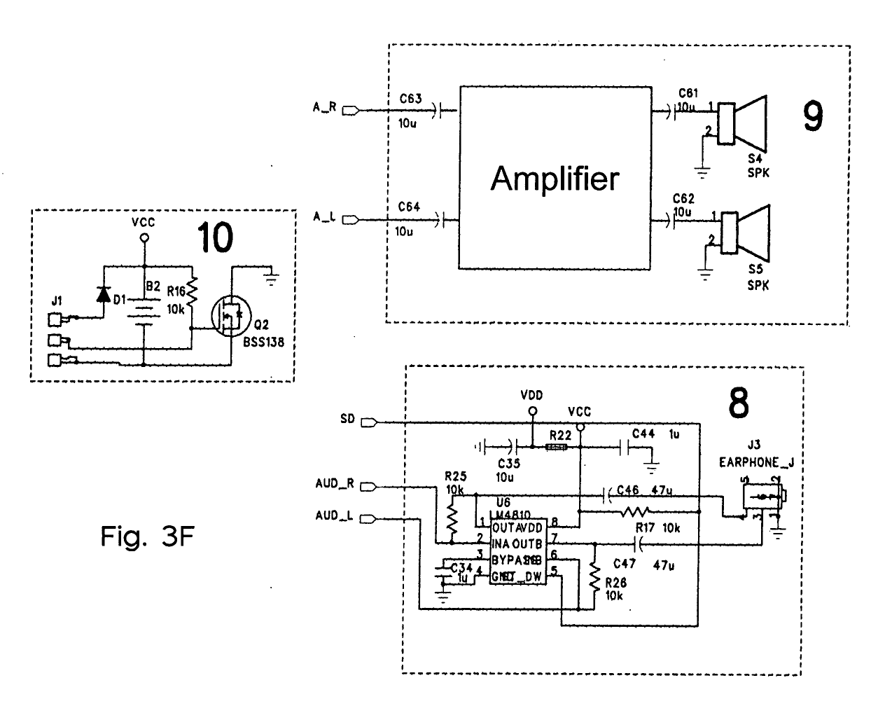

In FIG. 3F, a substantial configuration of the receiver is shown wherein the charging and switching circuit 10 of the receiver consists of a field effect transistor Q2, a diode D1, a resistor R3 and a battery B1; when being charged, the gate and the drain of the field effect transistor Q2 are short-circuited and the field effect transistor Q2 is cut off, thus the entire device is separated from the power supply board and the entire device is not conducted while the entire device is powered when the voltage level of the power supply going through the diode and the gate of Q2 is high and conducting the field effect transistor Q2.

In FIG. 3A, 3B, 3C and 3D, radio frequency receiving circuit 3 includes a forwardly positioned Q1, and peripheral circuit and a mixer circuit consisting of triode Q3; phase lock loop circuit 4 includes phase lock loop U3 and voltage controlled oscillator circuit consisting of triodes Q6, Q7 and Q8 and produces local oscillation signal needed for frequency mixing. Demodulation circuit 5 comprises X3 for FM demodulation and comparator U1-A wherein X3 demodulates FSK signal and U1-A detects the data stream DATA, and then it is sent to the central processing and AD converting circuit.

In FIG. 3E, the central processing and AD converting circuit 7 of the receiver is configurationally the same as the central processing and AD converting circuit 0 of the transmitter. The process of operation thereof is: when digital signal processor U1 receives the digital pulse signal from radio frequency receiving module M1, the signal is decoded and decompressed as audio serial data output SDTO which is sent to the audio frequency AD converter U2 and clock signals LCR, MCLK and SCLK are also sent to audio frequency AD converter U2; the audio frequency AD converter U2 receives the audio serial data output from the digital signal processor U1 and then converts said output to audio frequency signal, and then sent it to the audio frequency amplifying circuit 8 through capacitors C18, C19, C32 and C33.

In FIG. 3F, the audio frequency amplifying circuit 8 is provided with a functional interface that handily connects to the loudspeaker. The process of operation thereof is: the amplifier U6 of the audio frequency amplifying circuit 8 amplifies the audio frequency from the audio frequency AD converter U2 of the central processing and AD converting circuit 7 and then sends the audio frequency to the loudspeaker. The voltage level of LED pin of the digital signal processor U1 is high when signal is not available, where the high voltage level is used for controlling the shut down terminal ST-DW of the audio frequency amplifying circuit 8 in order to cut off the power of amplifier U6 for energy saving.

The amplifying circuit 9 includes amplifier and sound boxes S4 and S5. The audio frequency signal can be played by the sound boxes through the amplifier when the headphone is not in use.

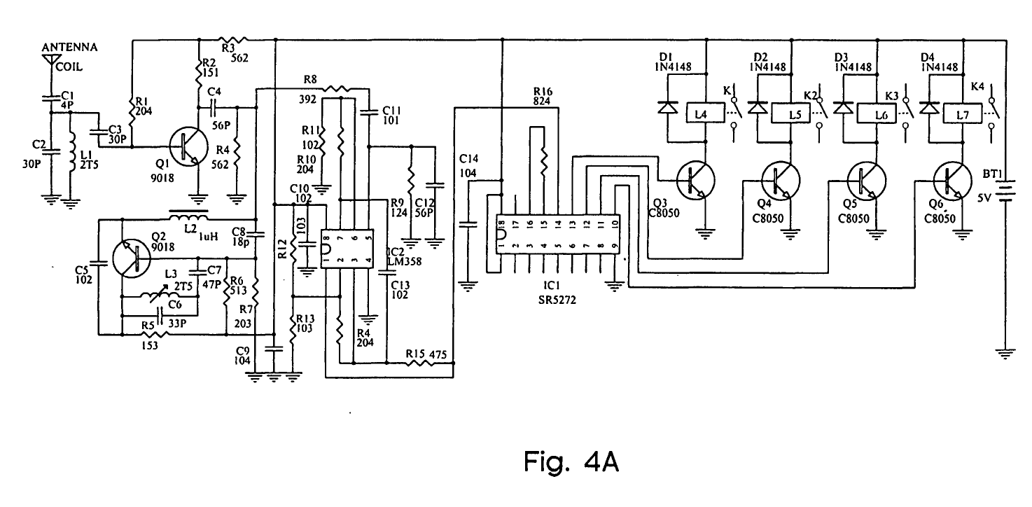

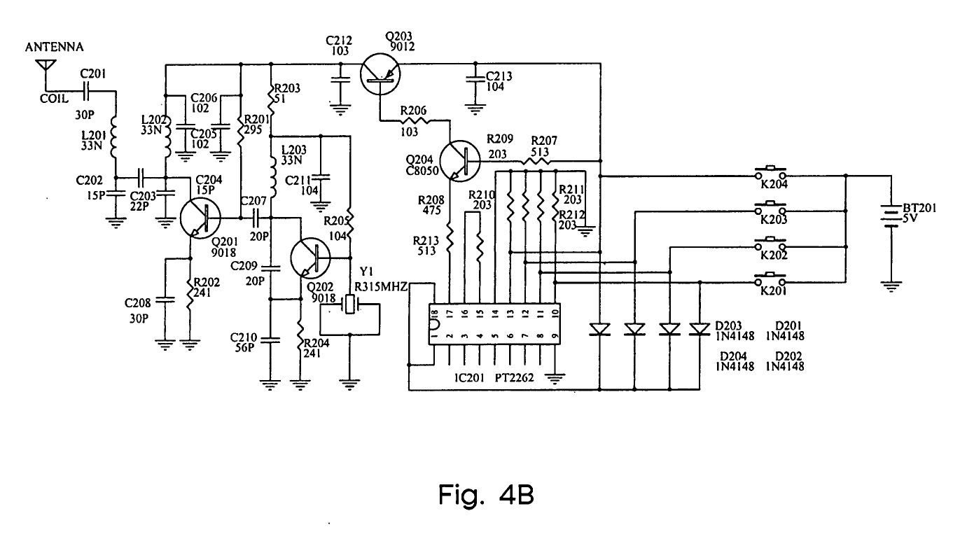

The configuration of the remote controller is shown in FIG. 4A and 4B, which is a known one and consists of a wireless receiving control circuit 71(shown in FIG. 4A) and a wireless transmitting circuit 72(shown in FIG. 4B). The capacitors C6, C7 and inductor L3 of the wireless receiving control circuit 71 are frequency selecting network; R4 to R7 are bias resistors of triode Q2 and the signal is transmitted to pin 5 of chip IC2 (LM358) through resistor 8 and capacitor C11; the signal is reshaped and amplified and then output from pin 1 of chip IC2 to pin 14 of IC1; after being decoded by chip IC1, the signal is output from pin 10 to 13 and controls the operation of various switch elements K1 to k4 of relay L4 to L7 through triodes Q3 to Q6. Resistor R16 being an oscillatory resistor of the chip IC1 provides operating clock for chip IC1. Diodes D1 to D4 are balancing diodes of the relay L4 to L7.

The diodes D201 to D204 of the wireless transmission circuit 72 provide power to chip IC2; resistor R208 being an oscillatory resistor provides operating clock for chip IC201; resistors R206, R207 and R213 are bias resistors of triode Q204; R201 and R202 are bias resistors of triode Q201; capacitor C210 is bypass capacitor of triode Q202; relay L203 and capacitor C209 are feedback loop of triode Q202; capacitor C208 is bypass capacitor of triode Q201; relay L201 and capacitor C202 are frequency selecting loop of Q201 and capacitors C201, C203, and C207 are coupling capacitors.

The process of operation (shown in 4A and 4B) of the remote controller of wireless digital music playing and transmitting device for portable DVD/CD player according to the present invention is as follows: when receiving signal from the antenna by the receiving circuit of the remote controller, the signal is amplified through triode Q1 to which capacitors C1 and C3 are coupled; the antenna absorbing loop consists of capacitor C2 and inductor L1; resistors R1, R2 and R3 are bias resistors of triode Q1; mixer circuit comprises triode Q2 and its peripheral units L2, L3, C5, C6, C7, C8 and R4 to R8.

When pressing the switches K201 to K204 of remote controller respectively for transmission, the data signal is input from pins 10 to 13 of the chip IC201, after being decoded by chip IC202 (PT2262), it is output from pin 17 of chip IC201, and then transmitted via triode Q204 and Q203, relay L202, capacitor C203, relay L201, capacitor C201 and by the antenna, whereby the wireless digital music playing and transmitting device for portable DVD/CD player can be controlled.

1. A wireless digital music playing and transmitting device for portable DVD/CD player, characterized in that a transmitter consists of a central processing and audio frequency AD converting circuit, a radio-frequency module, an indicating lamp and a power control circuit; output terminals of the central processing and audio frequency AD converting circuit are connected to the radio-frequency module, the indicating lamp and the power control circuit; the transmitter is provided with a functional interface which is capable of connecting a DVD/CD player or a microphone; a receiver consists of at least one set of switching circuits, a radio-frequency receiving module, a central processing and AD converting circuit and an audio-frequency amplifier circuit; output terminals of said radio-frequency receiving module are connected to the central processing and AD converting circuit, output terminals of the central processing and AD converting circuit are connected to the audio-frequency amplifier circuit, and the audio-frequency amplifier circuit is provided with a functional interface connecting to a loudspeaker.

2. The wireless digital music playing and transmitting device for portable DVD/CD player according to claim 1, characterized in that said device is also provided with a remote controller for controlling the receiver at non-mobile situation.

3. The wireless digital music playing and transmitting device for portable DVD/CD player according to claim 1, characterized in that the central processing and AD conversing circuit 0 comprises digital signal processor U1, audio frequency AD converter U2, first clock circuit X1 and second clock circuit X2; the audio frequency AD converter U2 is AK4550, an operating clock thereof, including a master clock MCLK and an input/output channel clock LRCK, is provided by the digital signal processor U1; the digital signal processor U1 is an interface IC implementing the connection of the audio frequency AD converter U2 with the radio frequency transmitting circuit 1, via the interface IC the audio frequency information is transmitted to the radio frequency module M1 of radio frequency transmitting circuit 1 and the control signal back from the receiver is received.

4. The wireless digital music playing and transmitting device for portable DVD/CD player according to claim 2, characterized in that the central processing and AD conversing circuit 0 comprises digital signal processor U1, audio frequency AD converter U2, first clock circuit X1 and second clock circuit X2; the audio frequency AD converter U2 is AK4550, an operating clock thereof, including a master clock MCLK and an input/output channel clock LRCK, is provided by the digital signal processor U1; the digital signal processor U1 is an interface IC implementing the connection of the audio frequency AD converter U2 with the radio frequency transmitting circuit 1, via the interface IC the audio frequency information is transmitted to the radio frequency module M1 of radio frequency transmitting circuit 1 and the control signal back from the receiver is received.
